(19) United States
(12) Patent Application Publication
(10) Pub. No.: US 2026/0176893 A1
(43) Pub. Date: Jun. 25, 2026

(54) WORK MACHINE

(71) Applicant: KUBOTA CORPORATION, Osaka (JP)

(72) Inventor: lbuki ISHIHARA, Osaka (JP)

(73) Assignee: KUBOTA CORPORATION, Osaka (JP)

(21) Appl. No.: 19/416,629

(22) Filed: Dec. 11, 2025

(30) Foreign Application Priority Data
Dec. 20, 2024 (JP) 2024-225593

(51) Int. Cl. E05B 77/16; E05B 85/16

(52) U.S. Cl. CPC E05B 77/16; E05B 85/16

(57) ABSTRACT

A work machine includes an openable/closable door including a door body and a hinge having a first shaft, and a lock mechanism that holds the openable/closable door in an opened state. The lock mechanism includes a second shaft, an engaging member that is swingably supported by the second shaft, and a pin. The engaging member includes a body portion having a plate shape, a shaft hole in the body portion through which the second shaft is inserted, and a hook portion separated from the shaft hole, the second shaft revolves about the first shaft according to pivot of the door body around the first shaft, the engaging member swings around the second shaft according to the revolution of the second shaft about the first shaft, and the hook portion engages with the pin such that the door body is disposed at a predetermined opened position.

### TECHNICAL FIELD

The present invention relates to a work machine.

The present application claims priority based on Japanese Patent Application No. 2024-225593 filed on Dec. 20, 2024, the entire contents of which are incorporated herein by reference.

### BACKGROUND ART

Conventionally, there has been known a work machine including a space for accommodating a normal tool (for example, a grease gun) for maintenance and the like in a cover constituting an exterior of a machine body (see Japanese Laid-Open Patent Publication No. 2015-031115). The work machine of Japanese Laid-Open Patent Publication No. 2015-031115 includes an openable/closable door that is openable and closable for the space. The work machine disclosed in Japanese Laid-Open Patent Publication No. 2015-031115 is a backhoe, and a left cover constituting the exterior of the machine body includes the openable/closable door.

### CITATION LIST

### Patent Literature

PATENT LITERATURE 1: Japanese Laid-Open Patent Publication No. 2015-031115

### SUMMARY OF THE INVENTION

### Technical Problem

A configuration of the conventional openable/closable door including a lock mechanism that automatically holds a pivoted position (opening degree) of the door when the door is opened up to a predetermined pivoted position (for example, a fully-opened position), has been known. However, with the conventional lock mechanism, there is a case where, when the machine body is inclined, for example, improper lock occurs before the door reaches the predetermined pivoted position.

An object of the present disclosure is to inhibit erroneous operation of a lock mechanism in a work machine provided with an openable/closable door that includes the lock mechanism.

### Solution to Problem

A work machine of the present disclosure includes a machine body, a cover that constitutes an exterior of the machine body, an openable/closable door that is provided in the cover and includes a door body and a hinge that includes a first shaft pivotably supporting the door body on the cover, and a lock mechanism that is capable of holding the openable/closable door in an opened state, in which the lock mechanism includes a second shaft that has an axis parallel to an axis of the first shaft and that is fixed to the door body, an engaging member that is swingably supported by the second shaft, and an engaged member that is fixed to the cover, in which the engaging member includes a body portion that has a plate shape, a shaft hole that is defined in the body portion and through which the second shaft is inserted, and a hook portion that is formed at a position separated from the shaft hole in the body portion, the second shaft revolves about the first shaft according to pivot of the door body around the first shaft, the engaging member swings around the second shaft according to the revolution of the second shaft about the first shaft, and the hook portion engages with the engaged member in a state in which the door body is disposed at a predetermined opened position.

### Advantageous Effects of the Invention

According to the present disclosure, in the work machine provided with the openable/closable door that includes the lock mechanism, the erroneous operation of the lock mechanism can be inhibited.

### BRIEF DESCRIPTION OF DRAWINGS

FIG. 1 is a left side view schematically illustrating a work machine according to one embodiment of the present disclosure.

FIG. 2 is a perspective view illustrating a left cover (in a state in which an openable/closable door is closed).

FIG. 3 is a perspective view illustrating the left cover (in a state in which the openable/closable door is opened).

FIG. 4 is a perspective view illustrating a first hinge and a lock mechanism.

FIG. 5 is a perspective view illustrating a second hinge.

FIG. 6 is a partial sectional view illustrating the openable/closable door and the lock mechanism.

FIG. 7 is an explanatory diagram (part 1) of motion of the lock mechanism.

FIG. 8 is an explanatory diagram (part 2) of the motion of the lock mechanism.

FIG. 9 is an explanatory diagram illustrating a restricted state of an engaging member when the openable/closable door is in a closed state.

### DETAILED DESCRIPTION

### Outline of Embodiment of Present Disclosure

Hereunder, an outline of an embodiment of the invention of the present disclosure will be listed and described.
(1) A work machine of the present disclosure includes a machine body, a cover that constitutes an exterior of the machine body, an openable/closable door that is provided in the cover and includes a door body and a hinge that includes a first shaft pivotably supporting the door body on the cover, and a lock mechanism that is capable of holding the openable/closable door in an opened state, in which the lock mechanism includes a second shaft that has an axis parallel to an axis of the first shaft and that is fixed to the door body, an engaging member that is swingably supported by the second shaft, and an engaged member that is fixed to the cover, in which the engaging member includes a body portion that has a plate shape, a shaft hole that is defined in the body portion and through which the second shaft is inserted, and a hook portion that is formed at a position separated from the shaft hole in the body portion, the second shaft revolves about the first shaft according to pivot of the door body around the first shaft, the engaging member swings around the second shaft according to the revolution of the second shaft about the first shaft, and the hook portion engages with the engaged member in a state in which the door body is disposed at a predetermined opened position.

In the lock mechanism having the above configuration, the use of the plate-shaped engaging member makes it possible to inhibit adherence of the engaging member to the second shaft. This makes it possible to cause the engaging member to swing while always drawing an intended trajectory. Hence, with the above configuration, in the work machine provided with the openable/closable door that includes the lock mechanism, erroneous operation of the lock mechanism can be inhibited.
(2) It is preferable that, in the work machine according to the above mode (1), the engaging member further include a projecting portion that extends from a middle portion of the body portion in a first direction that is a direction connecting the second shaft and the hook portion toward a second direction intersecting the first direction, and a center of gravity of the engaging member be located at a position away from a straight line in the first direction passing through a position of the axis of the second shaft.

With the lock mechanism having the above configuration, the projecting portion is provided and the position of the center of gravity of the engaging member is adjusted, whereby the engaging member can be caused to naturally swing by action of its own weight when the door body is changed from a closed state to an opened state. This makes it possible to cause the engaging member to swing while always drawing an intended trajectory. Hence, with the above configuration, in the work machine provided with the openable/closable door that includes the lock mechanism, the erroneous operation of the lock mechanism can be inhibited.
(3) It is preferable that, in the work machine according to the above mode (2), the door body in a state of being pivoted to a predetermined closed position be capable of coming into contact with the projecting portion, and pivot, exceeding a first predetermined angle, of the engaging member in a direction toward the door body be restricted by coming into contact with the door body.

With the lock mechanism having the above configuration, when the door body is brought to the closed state, displacement (swinging) of the projecting portion can be restricted by the door body. In this case, an orientation of the engaging member can be made fixed when the door body is in the closed state, which makes it possible to cause the engaging member to swing while drawing an intended trajectory.
(4) It is preferable that, in the work machine according to the above mode (1) or (2), the engaging member be disposed between the openable/closable door and the cover when the openable/closable door is in a state of being pivoted to a predetermined closed position, and pivot exceeding a second predetermined angle in a direction away from the openable/closable door be restricted by coming into contact with the cover.

With the lock mechanism having the above configuration, when the door body is brought to the closed state, displacement (swinging) of the projecting portion can be restricted by the door body. In this case, an orientation of the engaging member can be made fixed when the door body is in the closed state, which makes it possible to cause the engaging member to swing while drawing an intended trajectory.
(5) It is preferable that, in the work machine according to the above mode (3), the projecting portion additionally serve as a grip portion to be gripped when the engaging member is pivoted.

In the lock mechanism having the above configuration, it is not necessary to separately provide a part serving as the grip portion, and is possible to simplify the configuration of the lock mechanism.
(6) It is preferable that, in the work machine according to any one of the above modes (1) to (5), the hook portion include a first hooking portion that is formed on a rear side in a swinging direction of the engaging member when the door body is pivoted around the first shaft from the predetermined closed position to the predetermined opened position, a second hooking portion that is formed on a front side in the swinging direction, and a recessed portion that is formed between the first hooking portion and the second hooking portion, and in the first direction that is a direction connecting the second shaft and the hook portion, a length of the second hooking portion be longer than a length of the first hooking portion.

In the lock mechanism having such a configuration, the first hooking portion can ride over the engaged member, and the second hooking portion is unlikely to ride over the engaged member. Thus, with the lock mechanism having such a configuration, it is possible to reliably engage the engaged member and the recessed portion of the hook portion that rides over the engaged member with each other. This makes it possible to inhibit occurrence of improper lock in the lock mechanism.
(7) It is preferable that, in the work machine according to the above mode (6), the first hooking portion ride over the engaged member by applying an external force to the door body to pivot the door body around the first shaft from the predetermined closed position beyond the predetermined opened position, and by removing the external force, the engaged member be accommodated in the recessed portion and the engaging member engage with the engaged member.

With the lock mechanism having such a configuration, a natural handling on the openable/closable door by a user enables the engaging member and the engaged member to be engaged with each other.
(8) It is preferable that, in the work machine according to any one of the above modes (1) to (7), the engaged member be provided in the hinge.

With the lock mechanism having such a configuration, providing the engaged member in the hinge can make the lock mechanism compact.

### Details of Embodiment of Invention of Present Disclosure

Hereunder, details of an embodiment of the present disclosure will be described with reference to the drawings. Note that at least parts of the embodiment described below may be freely combined.

### [Overall Configuration of Work Machine]

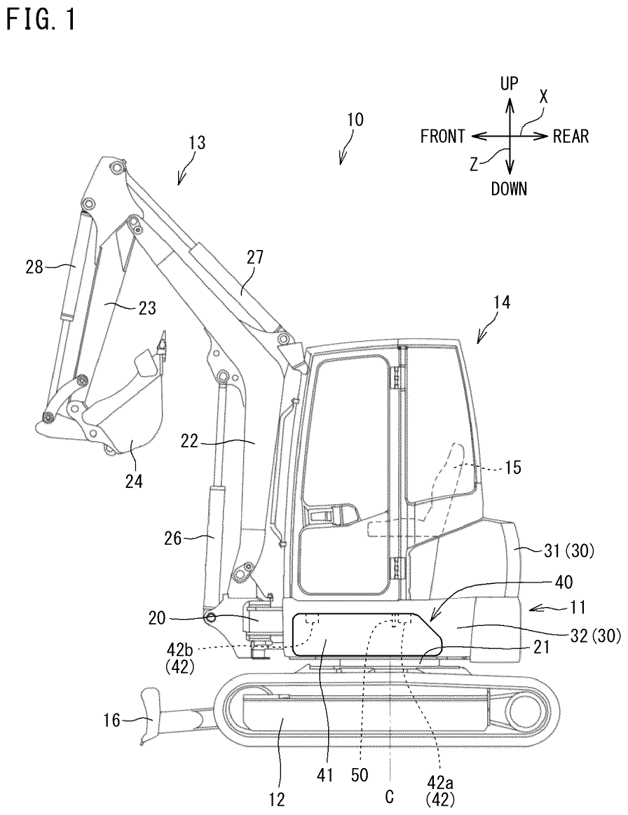

FIG. 1 is a left side view schematically illustrating a work machine according to one embodiment of the present disclosure. FIG. 1 illustrates a work machine 10 according to the one embodiment of the work machine of the present disclosure. The work machine 10 is a backhoe. As illustrated in FIG. 1, the work machine 10 includes a machine body 11, traveling devices 12, a working device 13, a cabin 14, and an operator's seat 15. The work machine 10 may have a configuration including a canopy in place of the cabin 14.

In the following description, with respect to the operator seated on the operator's seat 15, a direction toward the front side of the operator is referred to as the front of the work machine 10, and a direction toward the rear side is referred to as the rear thereof. The front-rear direction of the work machine 10 is indicated by an arrow X. Further, in the following description, a direction toward the left side of the operator seated on the operator's seat 15 is referred to as the left of the work machine 10, and a direction toward the right side is referred to as the right of the work machine 10. The left-right direction of the work machine 10 is indicated by an arrow Y. The left-right direction of the work machine 10 is also referred to as a width direction. Furthermore, in the following description, an up-down direction of the work machine 10 is indicated by an arrow Z. The up-down direction of the work machine 10 is orthogonal to the front-rear direction and the left-right direction.

As illustrated in FIG. 1, the traveling devices 12 are crawler-type traveling devices that support the machine body 11 in a travelable manner. The traveling devices 12 are driven by a hydraulic motor (not illustrated). In the present embodiment, the crawler-type traveling devices 12 are used; however, the configuration of the traveling devices in the work machine 10 of the present disclosure is not limited thereto, and traveling devices of a wheel-type or the like may be used. The work machine 10 further includes a dozer device 16. The dozer device 16 is provided in front of the traveling devices 12. The dozer device 16 may be provided on the front and rear portions of the work machine 10, or may be omitted.

### [Machine Body]

As illustrated in FIG. 1, the machine body 11 includes a slewing frame 20 and a cover 30. The slewing frame 20 and the cover 30 constitute an outer shell of the machine body 11. The machine body 11 has an engine (not illustrated) and other various devices mounted inside the outer shell constituted by the slewing frame 20 and the cover 30. While detailed description is omitted in the present description, the machine body 11 further includes, in addition to the engine, various devices, such as a fuel tank, a cooling fan, a radiator, an oil cooler, a fuel cooler, a slewing motor, a battery, a hydraulic pump, an exhaust gas purification device, an air cleaner, a hydraulic fluid tank, and a control valve, which are not illustrated.

The slewing frame 20 is provided above the traveling devices 12 via a slewing bearing 21. The slewing bearing 21 supports the machine body 11 on the traveling devices 12. The machine body 11 is configured to be turnable around a slewing axis C that the slewing bearing 21 has. The slewing axis C is an axis extending in the up-down direction of the machine body 11.

In the work machine 10 of the present disclosure, the cover 30 includes a rear cover (rear hood) 31 and a left cover 32. The cover 30 further includes a right cover, a tank cover, and the like (not illustrated). The rear cover 31 is a portion, of the cover 30, disposed on the rear side of the machine body 11. The left cover 32 is a portion, of the cover 30, disposed on the left side of the machine body 11. The left cover 32 includes an openable/closable door 40.

### [Working Device]

The working device 13 includes a boom 22, an arm 23, and a bucket 24. A base portion of the boom 22 is supported by a first horizontal shaft member of the slewing frame 20, and is configured to be pivotable around the first horizontal shaft member. The boom 22 swings as a boom cylinder 26 extends and contracts. The boom 22 includes, on its end side, a second horizontal shaft member extending in a direction orthogonal to the up-down direction. The arm 23 is supported by the second horizontal shaft member of the boom 22, and is configured to be pivotable around the second horizontal shaft member. The arm 23 swings as an arm cylinder 27 extends and contracts. The arm 23 includes, on its end side, a third horizontal shaft member extending in a direction orthogonal to the up-down direction. The bucket 24 is supported by the third horizontal shaft member of the arm 23, and is configured to be pivotable around the third horizontal shaft member. The bucket 24 swings as a bucket cylinder 28 extends and contracts. The boom cylinder 26, the arm cylinder 27, and the bucket cylinder 28 are configured with hydraulic cylinders (hydraulic actuators).

### [Openable/Closable Door]

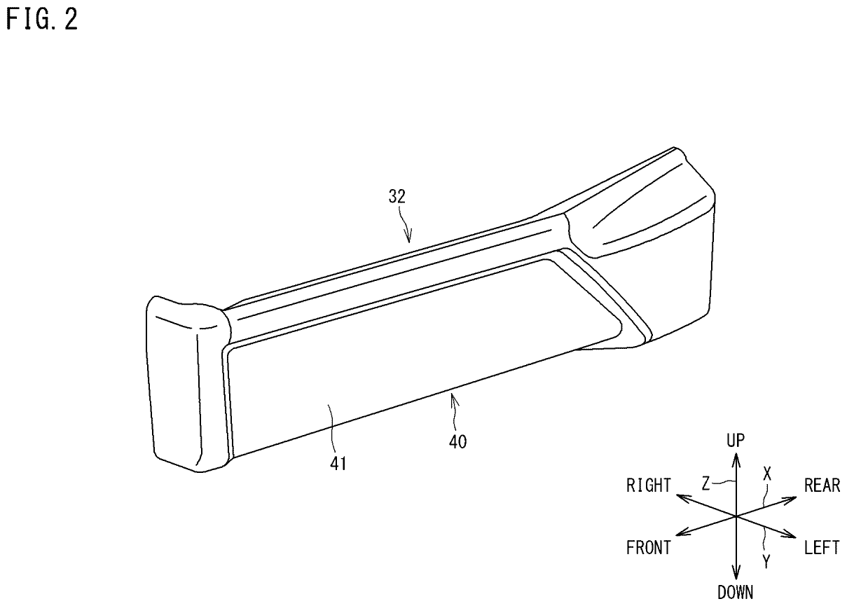

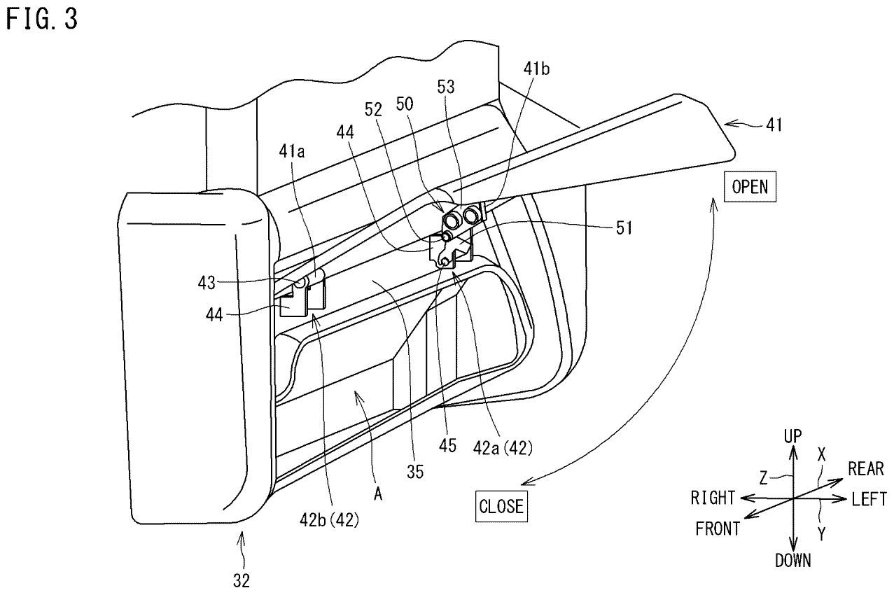

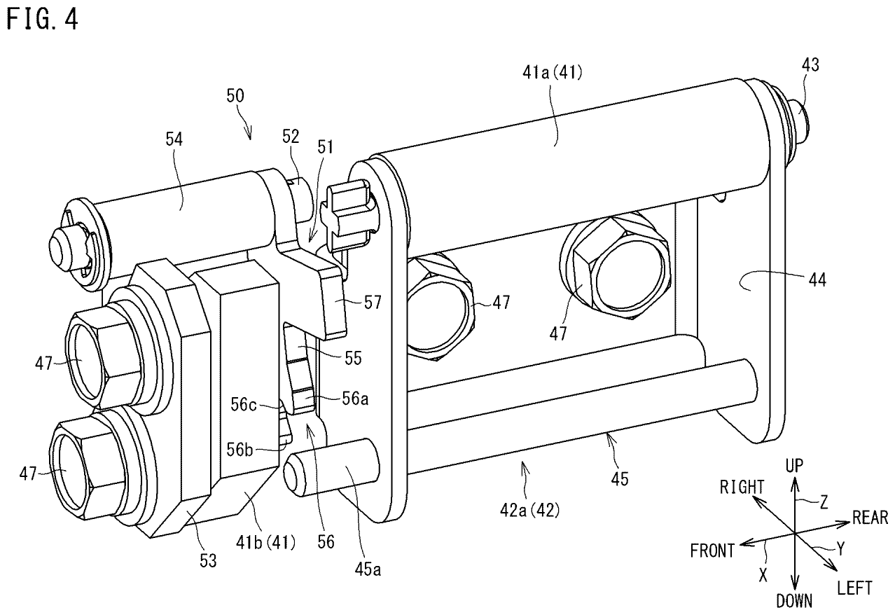

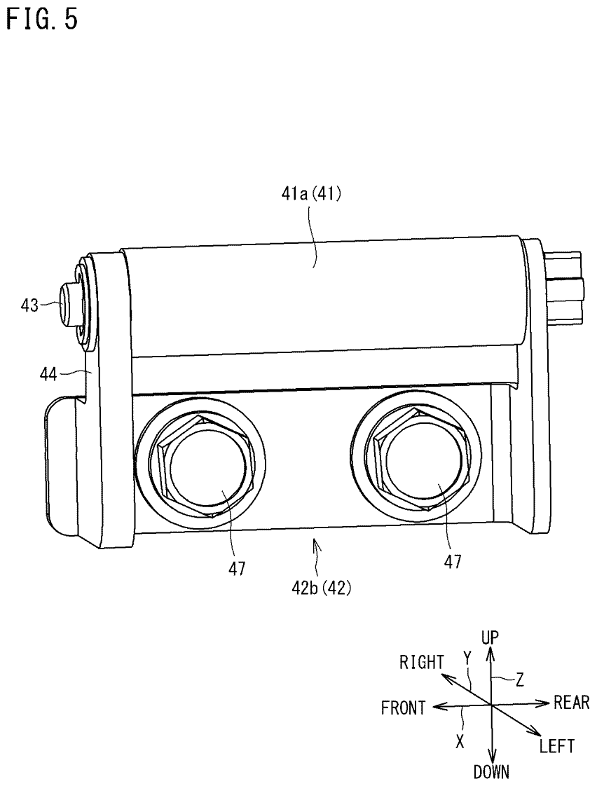

FIG. 2 is a perspective view illustrating the left cover (in a state in which the openable/closable door is closed). FIG. 3 is a perspective view illustrating the left cover (in a state in which the openable/closable door is opened). FIG. 4 is a perspective view illustrating a first hinge and a lock mechanism. FIG. 5 is a perspective view illustrating a second hinge. As illustrated in FIG. 1 and FIG. 2, in the work machine 10, the left cover 32 includes the openable/closable door 40. The openable/closable door 40 openably and closably covers a space A for accommodating a normal tool (for example, a grease gun), the space A being provided inside the left cover 32. FIG. 2 illustrates the state in which the openable/closable door 40 is “closed”, and FIG. 3 illustrates the state in which the openable/closable door 40 is “opened”. In the present embodiment, the case where the openable/closable door 40 is provided in the left cover 32 is exemplified; however, the installation place of the openable/closable door 40 is not limited thereto, and may be, for example, the rear cover 31, the right cover, the tank cover, or the like. Nor are the number, size, and shape of the openable/closable door 40 particularly limited.

As illustrated in FIG. 1 to FIG. 3, the openable/closable door 40 includes a door body 41 and a hinge 42. The left cover 32 and the door body 41 are made of a steel plate. The openable/closable door 40 constitutes a part of an outer shell of left cover 32. An upper side portion of the door body 41 is pivotably supported by the hinge 42. The hinge 42 includes a first hinge 42a and a second hinge 42b. The door body 41 is configured such that the door body 41 can be caused to pivot substantially upward, with the hinge 42 on an upper end side of the door body 41 serving as a fulcrum, by pulling a lower end side thereof toward a left side of the machine body 11.

In the present description, the state in which the openable/closable door 40 is “closed” is a state in which the door body 41 is pivoted to the closed position, and is hereunder also referred to as “closed state”. In the present description, the state in which the openable/closable door 40 is “opened” is a state in which the door body 41 is pivoted to a position (opened position) other than the closed position, and is hereunder also referred to as “opened state”. Further, in the present description, a state in which the openable/closable door 40 is “fully opened” is a state in which the door body 41 is pivoted to a fully-opened position, and is hereunder also referred to as “fully-opened state”. The door body 41 is, when being pivoted to the fully-opened position, held at the fully-opened position by the lock mechanism to be described later. Note that in the openable/closable door 40 of the present embodiment, the door body 41 is configured to be pivotable up to a position (hereunder, also referred to as an excess position) beyond the fully-opened position. The fully-opened position and the excess position in the present description are included in the opened position.

As illustrated in FIG. 3 to FIG. 5, the hinge 42 includes first shafts 43 that pivotably support the door body 41. The first shafts 43 are divided as a first hinge 42a side and a second hinge 42b side. The first shaft 43 on the first hinge 42a side and the first shaft 43 on the second hinge 42b side are coaxially arranged. While the openable/closable door 40 illustrated in the present embodiment pivotably supports the door body 41 with two hinges 42 (first hinge 42a and second hinge 42b), the number of the hinges 42 is not limited thereto, and is appropriately selected according to the size, shape, weight, and the like of the door body 41.

As illustrated in FIG. 3 to FIG. 5, the hinge 42 includes support stays 44 that support the first shafts 43. The support stays 44 are fixed to an inner-side surface 35 of the left cover 32 with fastening members (bolts) 47. The first shafts 43 are each inserted through a shaft member 41a having a cylindrical shape and attached to the door body 41.

As illustrated in FIG. 3 and FIG. 4, the first hinge 42a further includes a pin 45 that is an engaged member. The pin 45 constitutes a part of a lock mechanism 50 to be described later. The pin 45 is fixed to the support stay 44 in an orientation parallel to the first shaft 43. The pin 45 is disposed below the first shaft 43. An end portion 45a of the pin 45 protrudes forward of the support stay 44 (a side on which the lock mechanism 50 to be described later is disposed). As illustrated in FIG. 5, the second hinge 42b is different from the first hinge 42a in that the second hinge 42b does not include the pin 45, and the other configuration is common to that of the first hinge 42a. In the present embodiment, the case where the pin is employed as the engaged member is exemplified; however, an engaged member having a form other than the pin may be employed for the lock mechanism of the present disclosure.

### [Lock Mechanism]

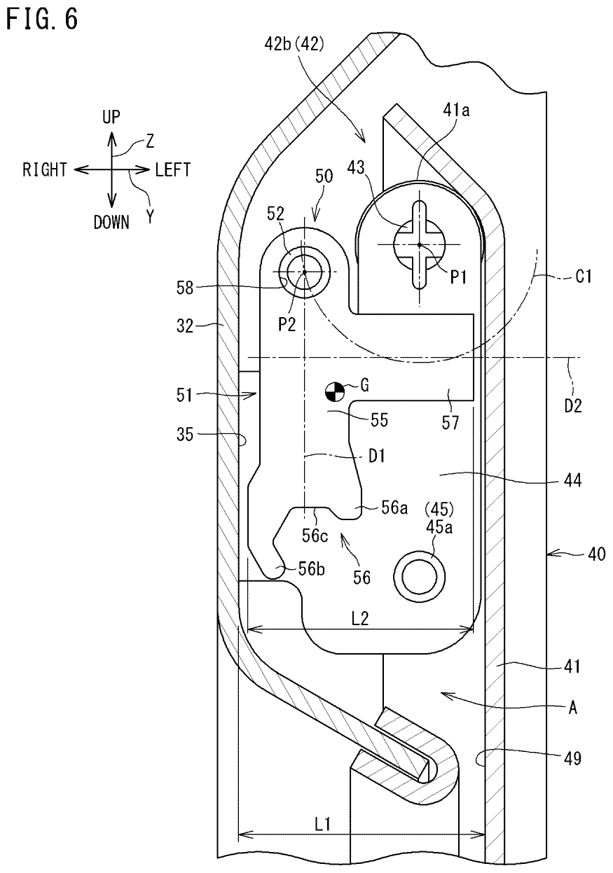

FIG. 6 is a partial sectional view illustrating the openable/closable door and the lock mechanism. In FIG. 6, for convenience of explanation, illustration of the members that are present in front of an engaging member 51 among the parts constituting the lock mechanism 50, is omitted. As illustrated in FIG. 3 and FIG. 6, the openable/closable door 40 includes the lock mechanism 50. The lock mechanism 50 is a mechanism that holds a pivoted position when the door body 41 is pivoted to the fully-opened position. In other words, the lock mechanism 50 is a mechanism that holds the door body 41 in the fully-opened state.

As illustrated in FIG. 4 and FIG. 6, the lock mechanism 50 includes the engaging member 51, a second shaft 52, a coupling plate 53, a cylindrical shaft 54, and the pin 45 described earlier. In the lock mechanism 50, the coupling plate 53 and the cylindrical shaft 54 are integrally formed and constitute a body portion of the lock mechanism 50. The coupling plate 53 is fixed to a stay portion 41b provided on the door body 41 with fastening members 47. The stay portion 41b is formed of a plate-shaped member that is provided, in a protruding manner, on a side surface of the door body 41, the side surface moving toward the inner side of the machine body 11. In the lock mechanism 50 of the present embodiment, the pin 45 is provided using the support stay 44 of the first hinge 42a to eliminate the necessity to secure an installation space for the pin 45, thereby achieving a compact configuration of the lock mechanism 50.

The cylindrical shaft 54 coaxially supports the second shaft 52 that is inserted therethrough. The second shaft 52 supported by the cylindrical shaft 54 is disposed parallel to the first shaft 43 that supports the door body 41. The second shaft 52 extends up to a position overlapping an area in which the end portion 45a of the pin 45 is present, in an axial direction of the pin 45 and a direction parallel thereto (the front-rear direction in the present embodiment). The second shaft 52 swingably supports the engaging member 51 in a portion overlapping with the area in which the end portion 45a is present.

The engaging member 51 engages with the end portion 45a of the pin 45. The lock mechanism 50 holds the door body 41 in the fully-opened state by engaging the engaging member 51 and the pin 45.

The engaging member 51 is a plate-shaped member made of a steel plate, and includes a body portion 55, a hook portion 56, and a projecting portion 57. The body portion 55 is a plate-like part that constitutes a main portion of the engaging member 51, and has a shape extending in a first direction D1. As illustrated in FIG. 6, the body portion 55 has a shaft hole 58 that is defined at an end on one side in the first direction D1. The body portion 55 (engaging member 51) is swingably supported by the second shaft 52 as a result of inserting the second shaft 52 through the shaft hole 58. The body portion 55 is allowed to be swingable in a state of hanging downward from the second shaft 52 by action of its own weight.

The hook portion 56 is a part engaged with the pin 45, and is formed at an end on the other side of the body portion 55 in the first direction D1. The hook portion 56 includes a first hooking portion 56a, a second hooking portion 56b, and a recessed portion 56c. The hook portion 56 engages with the pin 45 (end portion 45a) in the recessed portion 56c that is formed between the first hooking portion 56a and the second hooking portion 56b. In the first direction D1, the length of the second hooking portion 56b is longer than the length of the first hooking portion 56a.

The projecting portion 57 is a part that extends from a middle portion of the body portion 55 in the first direction D1 toward a second direction D2 intersecting the first direction D1. The projecting portion 57 is provided to adjust the position of a center of gravity G of the engaging member 51. The position of the center of gravity G of the engaging member 51 that is provided with the projecting portion 57 is shifted toward the projecting portion 57 side from a straight line extending in the first direction D1 through an axis of the shaft hole 58. This allows the engaging member 51 that swings in a state of hanging downward from the second shaft 52 to naturally swing by the action of its own weight such that the center of gravity G is located immediately below the second shaft 52. In this way, the engaging member 51 is configured to naturally assume an orientation inclined toward the projecting portion 57 side.

In the lock mechanism 50 of the present embodiment, the projecting portion 57 serves as a part (grip portion) for gripping the engaging member 51 when a user who opens and closes the openable/closable door 40 unlocks the lock mechanism 50.

As illustrated in FIG. 6, in the openable/closable door 40, the door body 41 is configured to be pivotable around the first shaft 43 about a position P1 of an axis of the first shaft 43. With the pivot of the door body 41 around the position P1 of the axis, the second shaft 52 revolves around the first shaft 43 while a position P2 of an axis of the second shaft 52 moves along an arc C1 centered at the position P1 of the axis. The engaging member 51 displaces in the left-right direction and the up-down direction along with the revolution of the second shaft 52, and swings by the action of its own weight. Further, the engaging member 51 is brought into contact with the end portion 45a of the pin 45 along with the displacement of the second shaft 52. The engaging member 51 in contact with the end portion 45a swings with a change in a relative position between the second shaft 52 and the pin 45, and is changed in orientation.

### [Motion of Lock Mechanism]

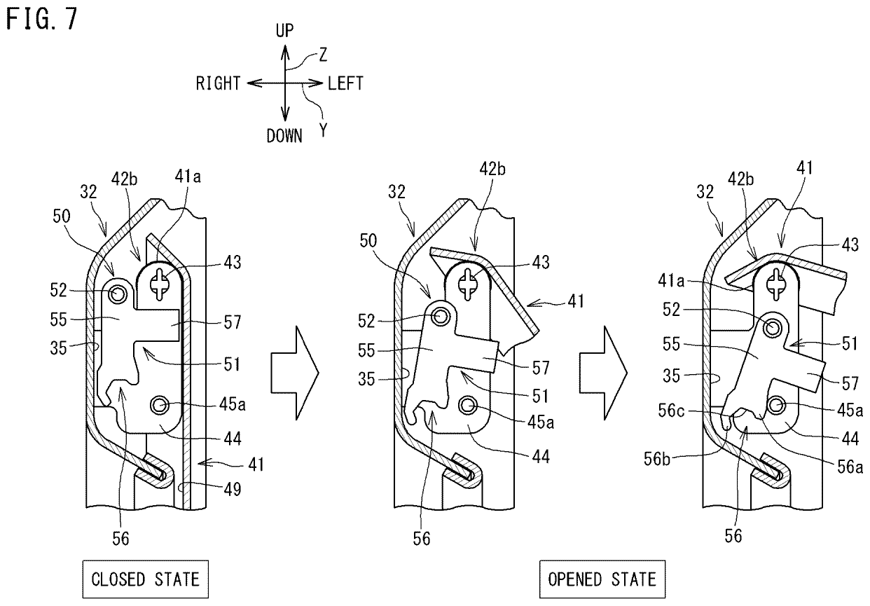

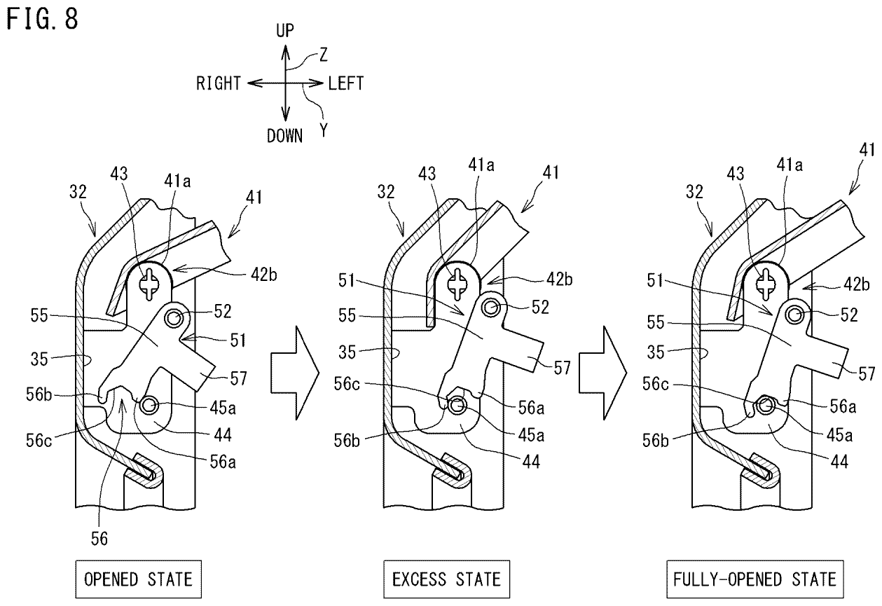

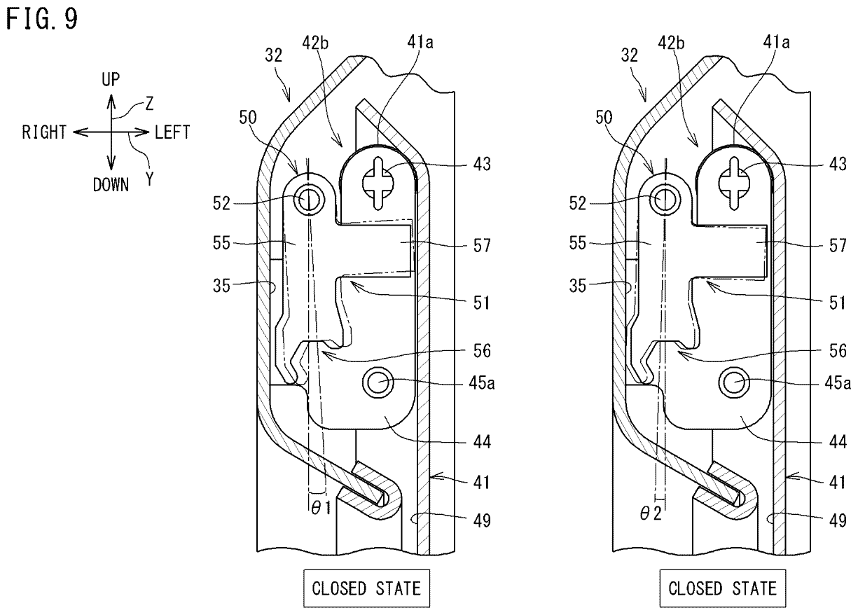

FIG. 7 is an explanatory diagram (part 1) of motion of the lock mechanism. FIG. 8 is an explanatory diagram (part 2) of the motion of the lock mechanism. FIG. 9 is an explanatory diagram illustrating a restricted state of the engaging member when the openable/closable door is in a closed state. Here, an operating state of the lock mechanism 50 when the door body 41 is pivoted from the closed position to the fully-opened position, will be described.

As illustrated in the left figure of FIG. 7, when the door body 41 is in the “closed state”, the engaging member 51 has the body portion 55 and the hook portion 56 located below the second shaft 52, and is allowed to be swingable around the second shaft 52.

When the door body 41 is in the “closed state”, the engaging member 51 is sandwiched between the inner-side surface 35 of the left cover 32 and an inner-side surface 49 of the door body 41. Hence, swinging of the engaging member 51 is restricted by the inner-side surface 35 and the inner-side surface 49. Note that in the present description, a mode in which the engaging member 51 is not in contact with the inner-side surface 35 and the inner-side surface 49, is illustrated in the left figure of FIG. 7; however, the engaging member 51 when the door body 41 is in the “closed state” may tilt clockwise in the left figure of FIG. 7 by the action of its own weight. The engaging member 51 in this case assumes an orientation in which the hook portion 56 (second hooking portion 56b) is in contact with the inner-side surface 35 and the projecting portion 57 is in contact with the door body 41.

As illustrated in the left figure of FIG. 9, in a case where the door body 41 is in the “closed state” and the engaging member 51 is pivoted in a direction (counterclockwise in the left figure of FIG. 9) that brings the engaging member 51 close to the door body 41, when being pivoted by a first predetermined angle θ1, the engaging member 51 (projecting portion 57) comes into contact with the door body 41 (inner-side surface 49), whereby pivot exceeding the first predetermined angle θ1 is restricted. As illustrated in the right figure of FIG. 9, in a case where the door body 41 is in the “closed state” and the engaging member 51 is pivoted in a direction (clockwise in the right figure of FIG. 9) that brings the engaging member 51 away from the door body 41, when being pivoted by a second predetermined angle θ2, the engaging member 51 (hook portion 56) comes into contact with the left cover 32 (inner-side surface 35), whereby pivot exceeding the second predetermined angle θ2 is restricted. In this way, when the door body 41 is in the “closed state”, clockwise and counterclockwise pivot of the engaging member 51 is restricted, so that the body portion 55 always assumes an orientation of hanging down vertically downward.

Next, as illustrated in the figure in the middle of FIG. 7, when the door body 41 is pivoted from the “closed” position toward the “fully-opened position” to bring the door body 41 into the “opened state”, the engaging member 51 swings by the action of its own weight such that the center of gravity G (see FIG. 6) is located immediately below the second shaft 52. At this time, the body portion 55 swings such that the hook portion 56 approaches the inner-side surface 35 (otherwise, the hook portion 56 maintains a state of being in contact with the inner-side surface 35). At this time, the orientation of the body portion 55 is such that its lower end side is closer to the inner-side surface 35 than its upper end side. The second shaft 52 displaces leftward along with the pivot of the door body 41, so that the engaging member 51 continues to swing clockwise in the figure in the middle of FIG. 7 until the center of gravity G (see FIG. 6) is located immediately below the second shaft 52.

Next, as illustrated in the right figure of FIG. 7, when the door body 41 is further pivoted toward the “fully-opened position”, in the engaging member 51, the first hooking portion 56a eventually comes into contact with the end portion 45a (pin 45). After the first hooking portion 56a comes into contact with the end portion 45a and before the first hooking portion 56a rides over the end portion 45a, when the door body 41 is further pivoted toward the “fully-opened position”, the engaging member 51 is tilted clockwise along with a change in a relative position between the second shaft 52 and the contact position of the first hooking portion 56a and the end portion 45a.

Next, as illustrated in the left figure of FIG. 8, when the door body 41 is further pivoted toward the “fully-opened position”, the engaging member 51 displaces leftward and upward along the arc C1 (see FIG. 6) and the engaging member 51 is further tilted clockwise about the second shaft 52.

Next, as illustrated in the figure in the middle of FIG. 8, when the door body 41 is further pivoted toward the “fully-opened position” to reach an “excess state”, the first hooking portion 56a rides over the end portion 45a. When the first hooking portion 56a rides over the pin 45, the engaging member 51 swings counterclockwise about the second shaft 52 by the action of its own weight. This allows the end portion 45a to enter the recessed portion 56c.

Then, as illustrated in the right figure of FIG. 8, when the user releases his/her hand from the door body 41, the door body 41 slightly pivots clockwise and is located at the “fully-opened position”. When the door body 41 is pivoted to the “fully-opened position”, the end portion 45a is fitted into the recessed portion 56c, and the hook portion 56 and the pin 45 (end portion 45a) engage with each other. This allows the door body 41 to be locked at the fully-opened position by the lock mechanism 50. In other words, the lock mechanism 50 holds the door body 41 in the “fully-opened state” by the engaging member 51 (hook portion 56) engaging with the pin 45 (end portion 45a). As described in the foregoing, the lock mechanism 50 can automatically hold the door body 41 in the “fully-opened state” only by the user handling and pivoting the door body 41 from the “closed” position toward the “fully-opened” position.

When pivoting the door body 41 from the “fully-opened” position to the “closed” position, the user once moves the door body 41 to the “excess state” (see the figure in the middle of FIG. 8), grips the projecting portion 57 in the “excess state”, and pivots the engaging member 51 clockwise in the figure in the middle of FIG. 8, thereby enabling the lock mechanism 50 to be unlocked. After unlocking the lock mechanism 50, the user can pivot the door body 41 clockwise to move the door body 41 to the “closed state”.

### [Occurrence of Improper Lock in Lock Mechanism]

A conventional lock mechanism provided in a work machine has a simple configuration in which no bearing or the like is provided between an engaging member and a shaft that supports the engaging member, from the viewpoint of cost reduction or the like. Hence, in the conventional lock mechanism, the engaging member and the shaft adhere to each other in some cases when the lock mechanism is not used for a certain period of time. It is expected that, in the conventional lock mechanism, the engaging member swings by the action of its own weight and assumes a predetermined orientation that is intended in design. However, there is a case where, in the conventional lock mechanism, the engaging member assumes an orientation that is not intended in design due to the adherence of the engaging member and the shaft. The conventional lock mechanism unfortunately causes improper lock by the engaging member assuming an unintended orientation. Note that the term “improper lock” as used herein refers to a phenomenon in which the door is brought to a locked state while the door is not in the “fully-opened state”.

As illustrated in FIG. 6, in the lock mechanism 50 of the present disclosure, a distance L1 from the inner-side surface 49 of the door body 41 to the inner-side surface 35 of the left cover 32 is set to be substantially equal to (but slightly larger than) a width of the engaging member 51 (a distance L2 from an outer-side surface of the second hooking portion 56b to an end surface of the projecting portion 57). With such a configuration, when the door body 41 is pivoted to the closed position, the swing of the engaging member 51 around the second shaft 52 is restricted by the door body 41 and the left cover 32. In other words, when the door body 41 is pivoted to the closed position, the engaging member 51 is disposed at a position sandwiched between the inner-side surface 49 and the inner-side surface 35 to restrict the swinging. The lock mechanism 50 having such a configuration can cause the engaging member 51 to always assume an intended orientation when the door body 41 is in the “closed state”. Hence, when the door body 41 is pivoted from the closed position toward the fully-opened position, the engaging member 51 always starts to swing from a fixed orientation. Hence, in the lock mechanism 50 of the present disclosure, the engaging member 51 reliably assumes a predetermined orientation that is intended in design, by the action of its own weight. Hence, the engaging member 51 always assumes an intended orientation, so that the lock mechanism 50 of the present disclosure can inhibit the occurrence of the improper lock.

The conventional lock mechanism provided in the work machine has a configuration in which a pin, which serves as a member to cause swing, made of a steel wire is employed, a guide groove is formed in a plate-shaped member, and the pin is caused to displace along this guide groove. In this case, since the pin itself is relatively light in weight, rotational torque generated when the pin swings by action of its own weight is insufficient, which increases the possibility that the pin adheres. On the contrary, the lock mechanism 50 of the present embodiment is configured such that the engaging member 51 made of a steel plate is swingable and the pin 45 is fixed to the cover 30 side. While letting the engaging member 51 freely swing, the engaging member 51 comes into contact with the pin 45 to be guided, whereby the engaging member 51 can be caused to displace along an intended trajectory. Further, the lock mechanism 50 of the present embodiment easily increases the weight of the engaging member 51 itself, and enables an increase in the rotational torque generated when the engaging member 51 swings by the action of its own weight. In addition, in the lock mechanism 50 of the present embodiment, a contact area between the engaging member 51 and the second shaft 52 in the shaft hole 58 is small, and the possibility that the engaging member 51 adheres to the second shaft 52 is kept low. Thus, the engaging member 51 of the present embodiment is less likely to cause the adherence of the swinging member, as compared with the conventional way in which the pin is employed as the swinging member. As a result, in the lock mechanism 50 of the present embodiment, the engaging member 51 can be reliably caused to displace on an intended trajectory while assuming an intended orientation, so that the improper lock is less likely to occur than in the conventional lock mechanism.

### [Functions and Effects of Present Embodiment]

(1) A work machine 10 of the present embodiment described above includes a machine body 11, a left cover 32 (cover 30) that constitutes an exterior of the machine body 11, an openable/closable door 40 that is provided in the left cover 32 and includes a door body 41 and a hinge 42 that includes a first shaft 43 pivotably supporting the door body 41 on the left cover 32, and a lock mechanism 50 that is capable of holding the openable/closable door 40 in an opened state. In the work machine 10 of the present embodiment, the lock mechanism 50 includes a second shaft 52 that has an axis parallel to an axis of the first shaft 43 and that is fixed to the door body 41, an engaging member 51 that is swingably supported by the second shaft 52, and a pin 45 that is fixed to the left cover 32. The engaging member 51 includes a body portion 55 that has a plate shape, a shaft hole 58 that is defined in the body portion 55 and through which the second shaft 52 is inserted, and a hook portion 56 that is formed at a position separated from the shaft hole 58 in the body portion 55. The second shaft 52 revolves about the first shaft 43 according to pivot of the door body 41 around the first shaft 43, the engaging member 51 swings around the second shaft 52 according to the revolution of the second shaft 52 about the first shaft 43, and the hook portion 56 engages with the pin 45 in a state in which the door body 41 is disposed at a predetermined opened position.

In the lock mechanism 50 of the present embodiment, the use of the plate-shaped engaging member 51 makes it possible to inhibit adherence of the engaging member 51 to the second shaft 52. This makes it possible to cause the engaging member 51 to swing while always drawing an intended trajectory. Hence, with the lock mechanism 50 having such a configuration, it is possible to inhibit erroneous operation of the lock mechanism 50 in the work machine 10 provided with the openable/closable door 40 that includes the lock mechanism 50.
(2) In the work machine 10 of the present embodiment, the engaging member 51 further includes a projecting portion 57 that extends from a middle portion of the body portion 55 in a first direction D1 that is a direction connecting the second shaft 52 and the hook portion 56, toward a second direction intersecting the first direction D1. A center of gravity G of the engaging member 51 is located at a position away from a straight line in the first direction D1 passing through a position P2 of the axis of the second shaft 52.

With the lock mechanism 50 having such a configuration, the projecting portion 57 is provided and the position of the center of gravity G of the engaging member 51 is adjusted, whereby the engaging member 51 can be caused to naturally swing by the action of its own weight when the door body 41 is changed from a closed state to an opened state. This makes it possible to cause the engaging member 51 to swing while always drawing an intended trajectory. Hence, with the lock mechanism 50 having such a configuration, it is possible to inhibit erroneous operation of the lock mechanism 50 in the work machine 10 provided with the openable/closable door 40 that includes the lock mechanism 50.
(3) In the work machine 10 of the present embodiment, the door body 41 in a state of being pivoted to a predetermined closed position is capable of coming into contact with the projecting portion 57, and pivot, exceeding a first predetermined angle θ1, of the engaging member 51 in a direction toward the door body 41 is restricted by coming into contact with the door body 41.

With the lock mechanism 50 having such a configuration, when the door body 41 is brought to the closed state, displacement of the projecting portion 57 can be restricted by the door body 41. In this case, an orientation of the engaging member 51 can be made fixed when the door body 41 is in the closed state, which makes it possible to cause the engaging member 51 to swing while drawing an intended trajectory.
(4) In the work machine 10 of the present embodiment, the engaging member 51 is disposed between the openable/closable door 40 and the left cover 32 when the openable/closable door 40 is in a state of being pivoted to the predetermined closed position, and pivot exceeding a second predetermined angle θ2 in a direction away from the openable/closable door 40 is restricted by coming into contact with the left cover 32.

With the lock mechanism 50 having such a configuration, when the door body 41 is brought to the closed state, displacement of the engaging member 51 can be restricted by the left cover 32. In this case, the orientation of the engaging member 51 can be made fixed when the door body 41 is in the closed state, which makes it possible to cause the engaging member 51 to swing while drawing an intended trajectory.
(5) In the work machine 10 of the present embodiment, the projecting portion 57 additionally serves as a grip portion to be gripped when the engaging member 51 is pivoted.

In the lock mechanism 50 having such a configuration, it is not necessary to separately provide a part serving as the grip portion, and is possible to simplify the configuration of the lock mechanism 50.
(6) In the work machine 10 of the present embodiment, the hook portion 56 includes a first hooking portion 56a that is formed on a rear side in a swinging direction of the engaging member 51 when the door body 41 is pivoted around the first shaft 43 from the predetermined closed position to the predetermined opened position, a second hooking portion 56b that is formed on a front side in the swinging direction, and a recessed portion 56c that is formed between the first hooking portion 56a and the second hooking portion 56b, and in the first direction D1 that is a direction connecting the second shaft 52 and the hook portion 56, a length of the second hooking portion 56b is longer than a length of the first hooking portion 56a.

In the lock mechanism 50 having such a configuration, the first hooking portion 56a can easily ride over the pin 45, and the second hooking portion 56b is unlikely to ride over the pin. Thus, with the lock mechanism 50, it is possible to reliably engage the pin 45 and the recessed portion 56c of the hook portion 56 that rides over the pin 45 with each other. This makes it possible to inhibit occurrence of improper lock in the lock mechanism 50.
(7) In the work machine 10 of the present embodiment, the first hooking portion 56a rides over the pin 45 by applying an external force to the door body 41 to pivot the door body 41 around the first shaft 43 from the predetermined closed position beyond the predetermined opened position, and by removing the external force, the pin 45 is accommodated in the recessed portion 56c and the engaging member 51 engages with the pin 45.

With the lock mechanism 50 having such a configuration, a natural handling on the openable/closable door 40 by the user enables the engaging member 51 and the pin 45 to be engaged with each other.
(8) In the work machine 10 of the present embodiment, the pin 45 is provided in the first hinge 42a.

With the lock mechanism 50 having such a configuration, providing the pin 45 in the hinge 42 can make the lock mechanism 50 compact.

The embodiment is illustrative in all respects and is not restrictive. The scope of the present invention is defined not by the embodiment but by the claims, and includes all modifications within the scope equivalent to the configuration described in the claims.

### REFERENCE SIGNS LIST

10 work machine
11 machine body
40 openable/closable door
41 door body
42 hinge
43 first shaft
45 pin (engaged member)
50 lock mechanism
51 engaging member
52 second shaft
55 body portion
56 hook portion
56a first hooking portion
56b second hooking portion
56c recessed portion
57 projecting portion
D1 first direction
D2 second direction
G center of gravity (of engaging member)
θ1 first predetermined angle
θ2 second predetermined angle

1. A work machine comprising:
a machine body;
a cover that constitutes an exterior of the machine body;
an openable/closable door that is provided in the cover and includes a door body and a hinge that includes a first shaft pivotably supporting the door body on the cover; and
a lock mechanism that is capable of holding the openable/closable door in an opened state, wherein
the lock mechanism includes
a second shaft that has an axis parallel to an axis of the first shaft and that is fixed to the door body,
an engaging member that is swingably supported by the second shaft, and
an engaged member that is fixed to the cover, wherein
the engaging member includes
a body portion that has a plate shape,
a shaft hole that is defined in the body portion and through which the second shaft is inserted, and
a hook portion that is formed at a position separated from the shaft hole in the body portion,
the second shaft revolves about the first shaft according to pivot of the door body around the first shaft,
the engaging member swings around the second shaft according to the revolution of the second shaft about the first shaft, and
the hook portion engages with the engaged member in a state in which the door body is disposed at a predetermined opened position.

2. The work machine according to claim 1, wherein
the engaging member further includes a projecting portion that extends from a middle portion of the body portion in a first direction that is a direction connecting the second shaft and the hook portion toward a second direction intersecting the first direction, and
a center of gravity of the engaging member is located at a position away from a straight line in the first direction passing through a position of the axis of the second shaft.

3. The work machine according to claim 2, wherein
the door body in a state of being pivoted to a predetermined closed position is capable of coming into contact with the projecting portion, and
pivot, exceeding a first predetermined angle, of the engaging member in a direction toward the door body is restricted by coming into contact with the door body.

4. The work machine according to claim 1, wherein
the engaging member is disposed between the openable/closable door and the cover when the openable/closable door is in a state of being pivoted to a predetermined closed position, and
pivot exceeding a second predetermined angle in a direction away from the openable/closable door is restricted by coming into contact with the cover.

5. The work machine according to claim 2, wherein the projecting portion additionally serves as a grip portion to be gripped when the engaging member is pivoted.

6. The work machine according to claim 1, wherein
the hook portion includes a first hooking portion that is formed on a rear side in a swinging direction of the engaging member when the door body is pivoted around the first shaft from a predetermined closed position to the predetermined opened position, a second hooking portion that is formed on a front side in the swinging direction, and a recessed portion that is formed between the first hooking portion and the second hooking portion, and
in the first direction that is a direction connecting the second shaft and the hook portion, a length of the second hooking portion is longer than a length of the first hooking portion.

7. The work machine according to claim 6, wherein the first hooking portion rides over the engaged member by applying an external force to the door body to pivot the door body around the first shaft from the predetermined closed position beyond the predetermined opened position, and by removing the external force, the engaged member is accommodated in the recessed portion and the engaging member engages with the engaged member.

8. The work machine according to claim 1, wherein the engaged member is provided in the hinge.
